(19) United States
(12) Patent Application Publication
(10) Pub. No.: US 2018/0234286 A1
(43) Pub. Date: Aug. 16, 2018

(54) BASE STATION AND A METHOD FOR MANAGING THE DISTRIBUTION OF A PLURALITY OF FILES TO A USER EQUIPMENT

(71) Applicant: Huawei Technologies Co., Ltd., Shenzhen (CN)

(72) Inventors: Frederic GABRY, Munich (DE); Valerio BIOGLIO, Boulogne Billancourt (FR); Ingmar LAND, Boulogne Billancourt (FR)

(21) Appl. No.: 15/952,076

(22) Filed: Apr. 12, 2018

Related U.S. Application Data
(63) Continuation of application No. PCT/EP2015/073618, filed on Oct. 13, 2015.

(51) Int. Cl. H04L 29/06; H04L 12/801; H04L 29/08

(52) U.S. Cl. CPC H04L 29/06408; H04L 29/08117; H04L 47/14

(57) ABSTRACT

The embodiments of the invention relate to a base station configured to manage the distribution of a plurality of files to a user equipment located within a service area of a base station, wherein each file of the plurality of files is decomposed into a plurality of file fragments. The base station comprises a selector configured to select, for each micro base station of a plurality of micro base stations located within the service area of the base station, and for each file of the plurality of files, a subset of the plurality of file fragments of the file, and a distributor configured to distribute to each micro base station, for each file, the selected subset of the plurality of file fragments to cache the selected subset of the plurality of file fragments at respective micro base station.

### CROSS-REFERENCE TO RELATED APPLICATIONS

This application is a continuation of International Application No. PCT/EP2015/073618, filed on Oct. 13, 2015, the disclosure of which is incorporated herein by reference in its entirety.

### TECHNICAL FIELD

Generally, the embodiments of the present disclosure relate to wireless communications. More specifically, the embodiments of the present disclosure relate to a base station configured to manage the distribution of a plurality of files to an user equipment located within the service area of the base station and to a method of managing the distribution of a plurality of files to an user equipment located within the service area of a base station.

### BACKGROUND

Content caching in future wireless networks, e.g. 5G networks, has been proposed as a technique for increasing the network performance by offloading the backhaul and thus reducing the latency of content delivery to end users (X. Wang, M. Chen, T. Taleb, A. Ksentini, and V. C. M. Leung, “Cache in the air: Exploiting content caching and delivery techniques for 5G systems”, IEEE Communications Magazine, vol. 52, no. 2, pp. 131-139, February 2014). The idea of bringing content as close as possible to the user by caching at the wireless edge has been proposed recently (E. Bastug, M. Bennis, and M. Debbah, “Living on the edge: The role of proactive caching in 5G wireless networks,” IEEE Communications Magazine, vol. 52, no. 8, pp. 82-89, August 2014). In particular, distributed caching is adapted to the heterogeneous structure of future multi-tier networks (J. G. Andrews, “Seven ways that HetNets are a cellular paradigm shift,” IEEE Communications Magazine, vol. 51, no. 3, pp. 136-144, March 2013), where densely deployed micro-cell or small-cell base stations (SBS) equipped with storage capabilities are expected to serve mobile users in addition to the macro-cell base station (MBS) traditionally present in current cellular networks.

The idea of caching content at the edge of the network, in order to deal with the increasing data traffic in future wireless networks, has recently been investigated from numerous perspectives. In the literature, models for measuring the performance of caching in cache-enabled SBSs in terms of outage probability have been proposed (E. Bastug, M. Bennis, and M. Debbah, “Cache-enabled small cell networks: Modeling and tradeoffs”, in IEEE International Symposium on Wireless Communications Systems (ISWCS), Barcelona, Spain, August 2014). Moreover, caching has been investigated from an information-theoretical perspective, where caching metrics are defined and analyzed for large networks (U. Niesen, D. Shah, and G. W. Wornell, “Caching in wireless networks”, IEEE Transactions on Information Theory, vol. 58, no. 10, pp. 6524-6540, October 2012). It has been shown that caching at the edge of a wireless network provides significant gains in terms of energy efficiency, which is considered a fundamental metric for future wireless networks (B. Perabathini, E. Bastug, M. Kountouris, M. Debbah, and A. Contey, “Caching at the edge: a green perspective for 5G networks”, in IEEE International Conference on Communications (ICC), London, United Kingdom, June 2015).

Another interesting approach in recent works stems from the idea of using network coding techniques to place and deliver content to the caches at the wireless edge, in order to improve the theoretical performance limits of uncoded caching (K. Poularakis, V. Sourlas, P. Flegkas, and L. Tassiulas, “On exploiting network coding in cache-capable small-cell networks”, in IEEE Symposium on Computers and Communications (ISCC), Funchal, Portugal, June 2014).

Other aspects of edge caching have been discussed in the literature, e.g. the idea of using the mobility of users in the network to increase caching gains, or the possibility of exploiting the storage capabilities of mobile phones via caching content directly on the users' devices (N. Golrezaei, A. G. Dimakis, and A. F. Molisch, “Wireless device-to-device communications with distributed caching”, in IEEE International Symposium on Information Theory (ISIT), Cambridge, U.S.A., July 2012). K. Shanmugam, N. Golrezaei, A. G. Dimakis, A. F. Molisch, and G. Caire, “Femtocaching: Wireless content delivery through distributed caching helpers,” IEEE Transactions on Information Theory, vol. 59, no. 12, pp. 8402-8413, December 2013 assume knowledge of the connectivity graph, which leads to an NP-complete problem. Also, M. Ji, A. M. Tulino, J. Llorca and G. Caire “On the Average Performance of Caching and Coded Multicasting with Random Demands” IEEE International Symposium on Wireless Communications Systems (ISWCS), Barcelona, Spain, August 2014 assume knowledge of the connectivity graph, which leads to an NP-complete problem, and describe the use of network coding. A. Sengupta et al. “Learning distributed caching strategies in small cell networks”, IEEE International Symposium on Wireless Communications Systems (ISWCS), Barcelona, Spain, August 2014 discloses a complex caching scheme also assuming knowledge of the full connectivity graph.

Although some of the content caching attempts described above already lead to an improved network performance, there is still a need for further improvements. Thus, there is a need for an improved base station configured to manage the distribution of a plurality of files to at least one user equipment as well as an improved method of managing the distribution of a plurality of files to at least one user equipment located within the service area of a base station.

### SUMMARY

It is an object of the embodiments of the present disclosure to provide an improved base station configured to manage the distribution of a plurality of files to at least one user equipment as well as an improved method of managing the distribution of a plurality of files to at least one user equipment located within the service area of a base station.

The foregoing and other objects are achieved by the subject matter of the independent claims. Further implementation forms are apparent from the dependent claims, the description and the figures.

According to one aspect, a base station (also referred to as a macro base station or macro-cell base station) is configured to manage the distribution of a plurality of files to at least one user equipment located within the service area of the base station, wherein each file of the plurality of files can be decomposed into a plurality of file fragments. The base station comprises a selector configured to select for each micro base station of a plurality of micro base stations (also referred to as micro-cell or small-cell base stations) located within the service area of the base station and for each file of the plurality of files a subset of the plurality of file fragments of the file and a distributor configured to distribute to each micro base station of the plurality of micro base stations for each file of the plurality of files the selected subset of the plurality of file fragments for caching the selected subset of the plurality of file fragments at the respective micro base station for being available for download by the user equipment.

Dividing the files into file fragments and caching respective subsets of the file fragments at respective micro base stations allows reducing the backhaul traffic. Thus, an improved base station configured to manage the distribution of a plurality of files to at least one user equipment is provided.

In one embodiment, the base station further comprises a memory for storing the plurality of file fragments for each file for direct download by the user equipment.

Advantageously, the base station can act as a backup in case any file fragment is not available from the micro base stations serving an user equipment. Alternatively, file fragments can be stored in a database of a backend system, e.g. a mobile network.

In another embodiment, the base station further comprises a decomposer configured to decompose each file of the plurality of files into the plurality of file fragments.

Advantageously, files to be downloaded to a user equipment can be decomposed into a plurality of file fragments by the base station. Alternatively, file fragments can be provided to the base station by a backend system, e.g. a mobile network.

In yet another embodiment, the selector is configured to select for each micro base station and for each file a subset of the plurality of file fragments of the file by selecting for each micro base station and for each file the file fragments of the plurality of file fragments randomly.

Advantageously, a random selection makes it probable that neighboring micro base stations with overlapping service areas can provide different file fragments of a file to a user equipment.

In still another embodiment, the selector is configured to select for each micro base station and for each file a subset of the plurality of file fragments of the file by selecting for each micro base station the same number of file fragments of the plurality of file fragments.

Advantageously, having the same number of file fragments for a given file simplifies the file fragment selection process.

In another embodiment, the selector is configured to select for each micro base station and for each file a subset of the plurality of file fragments of the file by selecting for each micro base station the same number of file fragments of the plurality of file fragments, wherein the number of file fragments for a given file depend on the demand of the given file.

Advantageously, for files being more popular, i.e. being downloaded more often, more file fragments can be locally cached at the micro base stations than for files being less popular.

In yet another embodiment, the selector and the distributor are configured to periodically adapt the selection and distribution of file fragments to the micro base stations on the basis of a changing demand of the plurality of files. A dynamic adaption can advantageously react to a changing file demand, i.e. to changing file popularity.

In still another embodiment, the selector is configured to select for each micro base station and for each file a subset of the plurality of file fragments of the file by minimizing an average backhaul rate, a time delay and/or an energy consumption.

Advantageously, the optimization can be done in an application specific manner with respect to the backhaul traffic, the time delay and/or the energy consumption associated with downloading of the files.

In another embodiment, the selector is configured to select for each micro base station and for each file a subset of the plurality of file fragments of the file by determining the normalized numbers of file fragments qⱼ with 0≤qⱼ≤1 for all j from 1 to N for which the following equation is smaller than a predefined threshold, in particular a minimum:

Pₐₚₚ≙min_{q}_{₁}_{, . . . ,q}_{_{N}}Σᵢ₌₁^{S}Σⱼ₌₁^{N}aᵢpⱼ(1−qⱼ)ⁱ,

wherein N denotes the number of files, S denotes the total number of micro base stations within the service area of the base station, aᵢ denotes the proportion of user equipments covered by i micro base stations, pⱼ denotes a popularity measure of the j-th file and wherein Σⱼ₌₁^{N}qⱼ=M, where M denotes a measure for the cache size of the micro base stations.

In yet another embodiment, the distributor is configured to distribute to each micro base station of the plurality of micro base stations for each file of the plurality of files the selected subset of the plurality of file fragments at times, when the network traffic is below a certain threshold.

This implementation form advantageously allows to distribute the file fragments at times of low network traffic, e.g. at night, thereby putting less pressure on the network.

In still another embodiment, the file fragments have the same size.

According to another aspect, a micro base station is configured to cache for each file of a plurality of files a respective subset of file fragments for being available for download by a user equipment.

According to yet another aspect, a method of managing the distribution of a plurality of files to an user equipment located within the service area of a base station is disclosed, wherein each file of the plurality of files can be decomposed into a plurality of file fragments, the method comprising the steps of: selecting for each micro base station of a plurality of micro base stations located within the service area of the base station and for each file of the plurality of files a subset of the plurality of file fragments of this file, and distributing to each micro base station of the plurality of micro base stations for each file of the plurality of files the selected subset of the plurality of file fragments for caching the selected subset of the plurality of file fragments at the respective base station for being available for download by the user equipment.

In one embodiment, the method can be performed by the base station. In one embodiment, the method results directly from the functionality of the base station and its different implementation forms described above.

According to still another aspect, a computer program comprising program code for performing the method when executed on a computer is disclosed.

Aspects of the invention can be implemented in hardware and/or software.

### BRIEF DESCRIPTION OF THE DRAWINGS

Further embodiments of the invention will be described with respect to the following figures, in which:

FIG. 1 shows a schematic diagram illustrating a base station configured to manage the distribution of a plurality of files to a plurality of user equipment according to an embodiment;

FIG. 2 shows a schematic diagram illustrating a base station configured to manage the distribution of a plurality of files to a plurality of user equipment according to an embodiment;

FIG. 3 shows a schematic diagram illustrating a base station configured to manage the distribution of a plurality of files to a plurality of user equipment according to an embodiment;

FIG. 4 shows a schematic diagram illustrating steps of a method of managing the distribution of a plurality of files to a plurality of user equipment according to an embodiment;

FIG. 5 shows a schematic diagram illustrating a base station configured to manage the distribution of a plurality of files to a plurality of user equipment according to an embodiment;

FIG. 6 shows a schematic diagram illustrating a backhaul rate as a function of the cache size for four different file distribution schemes, including a file distribution scheme implemented in a base station according to an embodiment;

FIG. 7 shows a schematic diagram illustrating a backhaul rate as a function of the micro base station coverage radius for four different file distribution schemes, including a file distribution scheme implemented in a base station according to an embodiment;

FIG. 8 shows a schematic diagram illustrating a backhaul rate as a function of the Zipf parameter for four different file distribution schemes, including a file distribution scheme implemented in a base station according to an embodiment; and

FIG. 9 shows a schematic diagram illustrating a backhaul rate as a function of the number of files for four different file distribution schemes, including a file distribution scheme implemented in a base station according to an embodiment.

### DETAILED DESCRIPTION OF EMBODIMENTS

In the following detailed description, reference is made to the accompanying drawings, which form a part of the disclosure, and in which are shown, by way of illustration, specific aspects in which the present disclosure may be practiced. It is understood that other aspects may be utilized and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

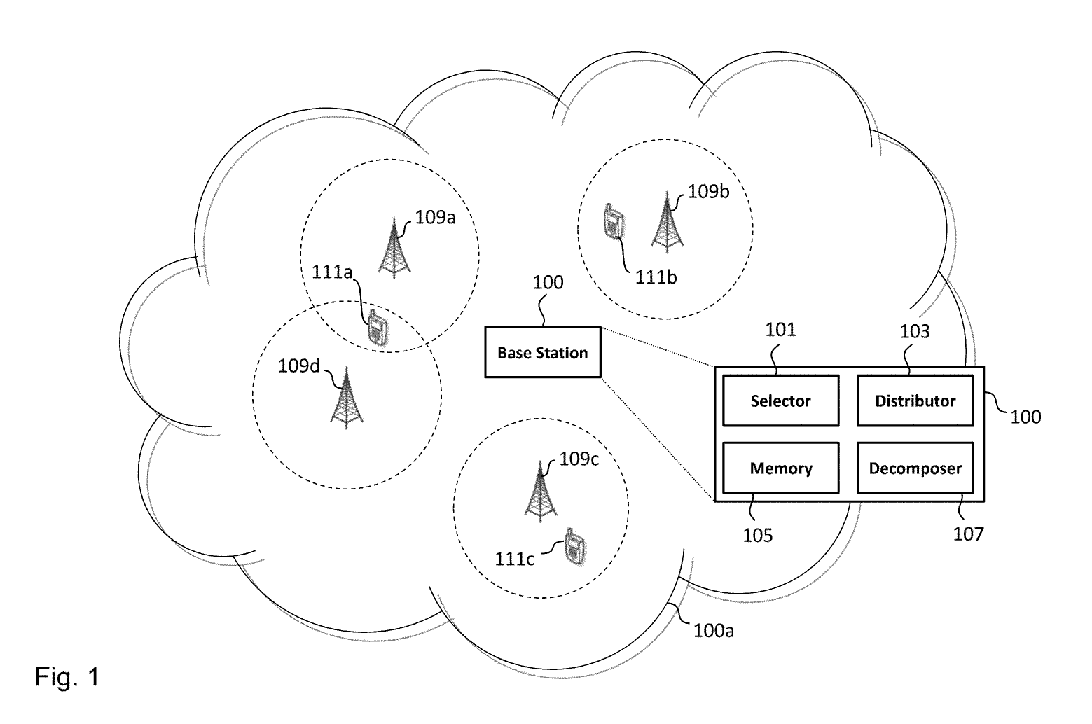

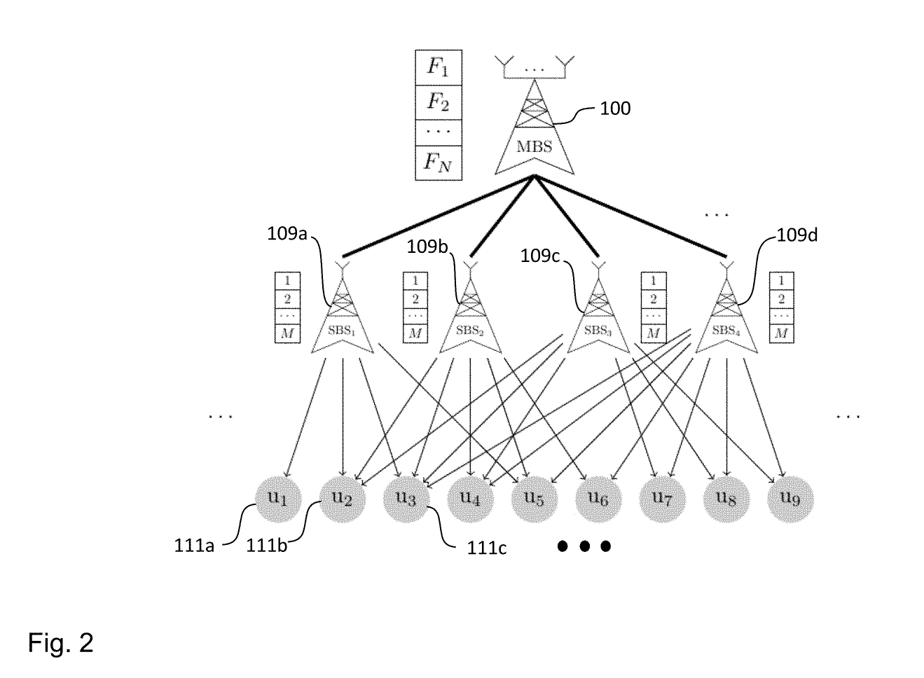

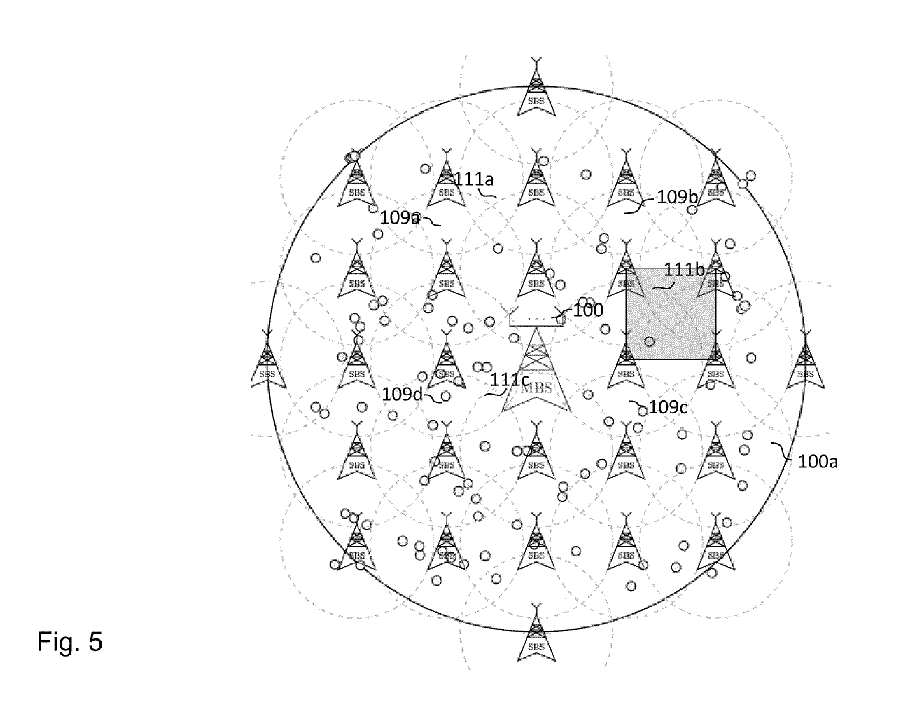

FIGS. 1, 2 and 3 show schematic diagrams of a base station 100 (also referred to as macro base station (MBS) or macro-cell base station 100 herein) according to embodiments of the invention. The base station 100 is part of a wireless communication network for communicating with a plurality of micro base stations 109a-d (also referred to as micro-cell or small-cell base stations 109a-d herein) as well as a plurality of user equipment or mobile stations 111a-c located within the service area 100a of the base station 100. The plurality of micro base stations 109a-d, in turn, are configured to communicate with one or more user equipment of the plurality of user equipment 111a-c located within the service area of a respective micro base station. By way of example, in the embodiment shown in FIG. 1 the micro base stations 109a and 109d are configured to communicate with the user equipment 111a, the micro base station 109b is configured to communicate with the user equipment 111b and the micro base station 109c is configured to communicate with the user equipment 111c. The person skilled in the art will appreciate that, although for the sake of simplicity FIG. 1 shows by way of example only four micro base stations and three user equipment, embodiments of the invention can be employed also in scenarios with a different, in particular larger number of micro base stations and/or user equipment. Preferably, the plurality of micro base stations are densely deployed within the service area 100a of the base station 100, i.e. cover overlapping areas of the service area 100a. A corresponding embodiment will be described further below in the context of FIG. 5.

A user equipment of the plurality of user equipment 111a-c could be, for instance, a mobile phone, a smart phone, a tablet computer, a communication module of a vehicle, a M2M module or any other type of mobile wireless communication device configured to download files over a wireless communication network. As is well known to the person skilled in the art, such user equipment can include hardware components, such as an antenna, a transceiver, a Long-Term Evolution (LTE) module, a WiFi module, a processor and/or the like to communicate over the wireless communication network. The wireless communication network used for communication between the macro base station 100 and the plurality of micro base stations 109a-d and the plurality of user equipment 111a-c could be a cellular wireless communication network, for instance, an LTE network, an LTE-A network or a future evolution thereof, such as 5G, or a WiFi network.

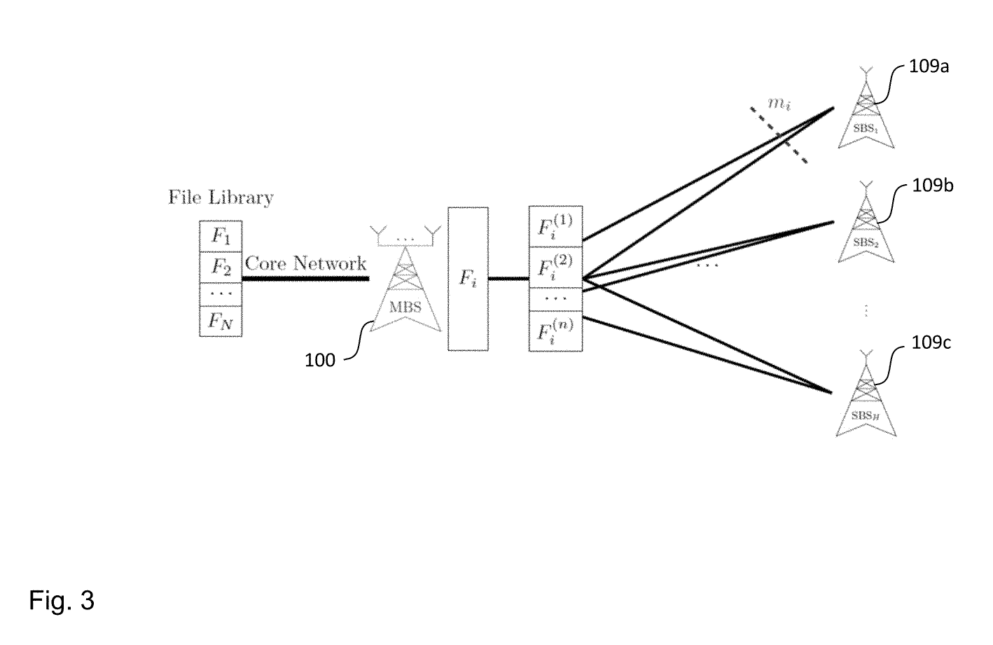

The base station 100 is configured to manage the distribution of a plurality of files to the plurality of user equipment 111a-c via the wireless communication network, wherein each file of the plurality of files can be decomposed into a plurality of file fragments. By way of example, for the following discussion it is assumed that the base station 100 supports a library of N files Fᵢ, i=1, 2, . . . , N, for distribution to the plurality of user equipment 111a-c. As illustrated in FIG. 3, in an embodiment these N files F, can be provided by a file library or a server in the core network or a backend system and cause traffic when provided to the base station 100. As further illustrated in FIG. 3, the file Fᵢ, for instance, can be decomposed or fragmented into n file fragments Fᵢ⁽¹⁾, Fᵢ⁽²⁾ . . . Fᵢ⁽ⁿ⁾. In an embodiment, the plurality of file fragments Fᵢ⁽¹⁾, Fᵢ⁽²⁾ . . . Fᵢ⁽ⁿ⁾ can have the same size.

As can be taken from the enlarged view shown in FIG. 1, the macro base station 100 comprises a selector 101 configured to select for each micro base station 109a-d and for each file Fᵢ of the plurality of files F₁ to F_{N} a subset of the plurality of file fragments Fᵢ⁽¹⁾, Fᵢ⁽²⁾ . . . Fᵢ⁽ⁿ⁾ of the file.

Moreover, the macro base station 100 comprises a distributor 103 configured to distribute to each micro base station 109a-d for each file Fᵢ of the plurality of files F₁ to F_{N} the selected subset of the plurality of file fragments Fᵢ⁽¹⁾, Fᵢ⁽²⁾ . . . Fᵢ⁽ⁿ⁾ such that the selected subset of the plurality of file fragments Fᵢ⁽¹⁾, Fᵢ⁽²⁾ . . . Fᵢ⁽ⁿ⁾ can be cached at the respective micro base station 109a-d for being available for download by the user equipment 111a-d.

In an embodiment, the base station 100 further comprises a memory 105 for storing the plurality of file fragments Fᵢ⁽¹⁾, Fᵢ⁽²⁾ . . . Fᵢ⁽ⁿ⁾ for each file Fᵢ for direct download by the user equipment 111a-c. In this embodiment, the macro base station 100 can act as a backup in case any file fragment is not available from the micro base stations 109a-d serving an user equipment 111a.

In an embodiment, the base station 100 further comprises a decomposer 107 configured to decompose each file Fᵢ of the plurality of files F₁ to F_{N} into the plurality of file fragments Fᵢ⁽¹⁾, Fᵢ⁽²⁾ . . . Fᵢ⁽ⁿ⁾. In this embodiment, the base station 100 can by means of the decomposer 107 decompose any file Fᵢ provided by the backend system into a plurality of file fragments Fᵢ⁽¹⁾, Fᵢ⁽²⁾ . . . Fᵢ⁽ⁿ⁾ for distributing a selection thereof to the plurality of micro base stations 109a-d. Alternatively or additionally, file fragments Fᵢ⁽¹⁾, Fᵢ⁽²⁾ . . . Fᵢ⁽ⁿ⁾ can be provided to the base station 100 by the backend system.

In an embodiment, the selector 101 is configured to select the file fragments constituting the subset of file fragments randomly from the plurality of file fragments Fᵢ⁽¹⁾, Fᵢ⁽²⁾ . . . Fᵢ⁽ⁿ⁾ for each file Fᵢ and for each micro base station 109a-d. Such a random selection from the plurality of file fragments Fᵢ⁽¹⁾, Fᵢ⁽²⁾ . . . Fᵢ⁽ⁿ⁾ makes it probable that neighboring micro base stations 109a-d with overlapping service areas can provide different file fragments of a file Fᵢ to the user equipment 111a-c.

In an embodiment, the selector 101 is configured to select the same number of file fragments for each micro base station 109a-d. Advantageously, having the same number of file fragments for a given file simplifies the file fragment selection process.

In an embodiment, the selector 101 is configured to select for each micro base station 109a-d and for each file Fᵢ a subset of the plurality of file fragments Fᵢ⁽¹⁾, Fᵢ⁽²⁾ . . . Fᵢ⁽ⁿ⁾ of the file Fᵢ by selecting for each micro base station 109a-d the same number of file fragments of the plurality of file fragments Fᵢ⁽¹⁾, Fᵢ⁽²⁾ . . . Fᵢ⁽ⁿ⁾, wherein the number of file fragments mᵢ for a given file Fᵢ depends on the demand of the file Fᵢ. For instance, in an embodiment the selector 101 is configured to select a number of file fragments m₁ for a file F₁ and a number of file fragments m₂ for a file F₂, wherein m₁ is larger than m₂, in case the file F₁ is more in demand, i.e. more popular, than the file F₂. Thus, advantageously, for files being more popular more file fragments can be locally cached at the micro base stations than for files being less popular.

In an embodiment, the selector 101 and the distributor 103 of the base station 100 are configured to periodically adapt the selection and distribution of file fragments Fᵢ⁽¹⁾, Fᵢ⁽²⁾ . . . Fᵢ⁽ⁿ⁾ for each file Fᵢ to the plurality of micro base stations 109a-d on the basis of a changing demand of the plurality of files. A dynamic adaption can advantageously react to a changing file demand.

In an embodiment, the selector 101 is configured to select for each micro base station 109a-d and for each file Fᵢ a subset of the plurality of file fragments Fᵢ⁽¹⁾, Fᵢ⁽²⁾ . . . Fᵢ⁽ⁿ⁾ of the file by minimizing the average backhaul rate, the time delay and/or the energy consumption. Advantageously, the optimization can be done in an application specific manner with respect to the backhaul traffic, the time delay and/or the energy consumption of the file transfers.

In the below an embodiment will be described, where the selector 101 is configured to select for each micro base station 109a-d and for each file Fᵢ a subset of the plurality of file fragments Fᵢ⁽¹⁾, Fᵢ⁽²⁾ . . . Fᵢ⁽ⁿ⁾ of the file such that the average backhaul rate is minimized. In this embodiment, each micro base station 109a-d has a cache or memory for storing file fragments, wherein the cache has a size M (in number of files) being smaller than the number of files N. In an embodiment, the N files F₁ to F_{N} can be assumed to have the same size.

As already mentioned above, the number of file fragments selected by the selector 101 from the plurality of file fragments Fᵢ⁽¹⁾, Fᵢ⁽²⁾ . . . Fᵢ⁽ⁿ⁾ of the file Fᵢ is denoted as mᵢ. A normalized version of mᵢ is given by qᵢ=mᵢ/n, wherein, as used above, n is the number of file fragments constituting the file Fᵢ. Each file Fᵢ is associated with a file demand or file popularity measure, which is denoted as pᵢ. In an embodiment, a file demand distribution can be modeled as a Zipf law of parameter α using the following equation:

$${p}_{j} = \frac{1 / j α}{{\sum }_{j} 1 / j α} ,$$

where α represents the skewness of the distribution and usually takes values in the range from 0.5 to 1.5. Aspects of the invention, however, are not limited to the case of Zipf popularity distributions.

The service area 100a covered by the base station 100 has a size A=πD² for an embodiment where the service area 100a is circular and the transmission range of the base station is D. Each micro base station 109a-d can cover a smaller area, but the service or coverage areas of the micro base stations preferably overlap, dividing the service area 100a into K sub-regions where a user equipment 111a-c can be served by more than one micro base station. Herein R^{k}ᵢ denotes the k-th sub-region having a size A^{k}ᵢ, where the subscript i denotes the number of micro base stations 109a-d that can serve this sub-region. In general two sub-regions R^{k}ᵢ and R^{k′}ᵢ may not have the same size even if they are covered by the same number i of micro base stations 109a-d, since aspects of the invention are not restricted to uniformly distributed micro base stations. Herein ρ^{k} denotes the density of user equipment 111a-c in the sub-region R^{k}ᵢ. As a consequence, the probability aᵢ that a user equipment 111a-c is in a sub-region served by i micro base stations 109a-d can be computed using the following equation:

$${a}_{i} = \frac{{\sum }_{k} {A}_{i}^{k} {ρ}^{k}}{{\sum }_{l} {\sum }_{k} {A}_{l}^{k} {ρ}^{k}} .$$

As already described above, each micro base station 109a-d receives mⱼ randomly drawn different fragments of the file Fⱼ to be stored in its cache with 0≤mⱼ≤n. Finding an optimal distribution scheme is equivalent to finding the optimal number of fragments mⱼ for each file Fⱼ to be stored in the micro base stations 109a-d in order to minimize the average backhaul rate experienced by a user equipment inside the service area 100a of the base station 100, which is herein defined as the average fraction of a file that needs to be downloaded from the base station 100 (and possibly consequently from the core network) in the case of a file request. This problem can be recast as a tractable convex optimization problem. Using qᵢ=mᵢ/n, i.e. the normalized version of mᵢ, given by qᵢ=mᵢ/n, the optimal number of fragments mⱼ for each file Fⱼ to be stored in the micro base stations 109a-d in order to minimize the average backhaul rate experienced by a user equipment inside the service area 100a of the base station 100 can be determined by solving the following equation (given the constraint Σⱼ₌₁^{N}qⱼ=M):

$${P}_{app} {=}^{Δ} {min}_{{q}_{1} , … , {q}_{N}} {\sum }_{i = 1}^{S} {\sum }_{j = 1}^{N} {a}_{i} {{p}_{j} ( 1 - {q}_{j} )}^{i} ,$$

wherein S denotes the total number of micro base stations 109a-d within the service area 100a of the base station 100. As the person skilled in the art will appreciate, an improved distribution scheme might already be provided by a set of values qᵢ, for which the above equation is not a minimum, but smaller than a predefined threshold. The convex optimization problem defined by the equation above can be solved in a straightforward manner using standard convex optimization methods (see e.g. “Convex Optimization”, S. Boyd, Cambridge University Press 2004).

As already described above, a file distribution scheme implemented in the base station 100 according to an embodiment can be considered to consist of two phases, namely a file fragment distribution phase and a file delivery phase.

During the file fragment distribution phase the caches of the micro base stations 109a-d are filled by the base station 100 on the basis of the file fragment distribution schemes described above. In an embodiment, the distributor 103 of the base station 100 is configured to distribute to each micro base station of the plurality of micro base stations 109a-d for each file Fᵢ of the plurality of files the selected subset of the plurality of file fragments at times, when the network traffic is below a certain threshold. Advantageously, this allows to distribute the file fragments at times of low network traffic, e.g. at night, thereby putting less pressure on the network.

During the delivery phase, the user equipment 111a-c requesting files are initially served by the micro base stations 109a-d covering their locations. If fragments of the requested files are not present in the caches of the micro base stations 109a-d, these file fragments have to be delivered through the backhaul from the base station 100.

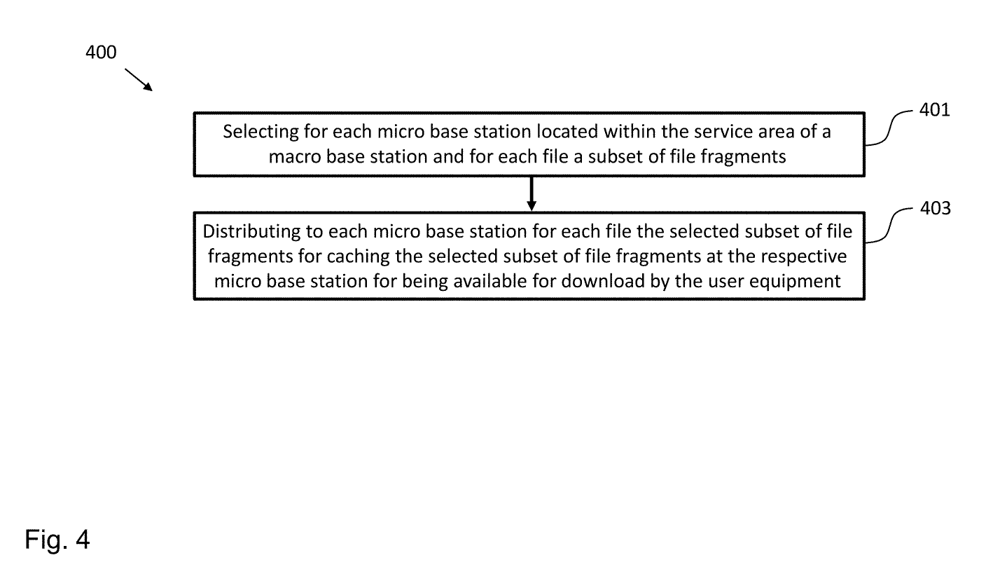

FIG. 4 shows a schematic diagram illustrating steps of a method 400 of managing the distribution of a plurality of files to an user equipment located within the service area of a base station, for instance, the base station 100 shown in FIGS. 1 to 3, wherein each file of the plurality of files can be decomposed into a plurality of file fragments, the method 400 comprises a first step 401 of selecting for each micro base station of a plurality of micro base stations located within the service area of the base station and for each file of the plurality of files a subset of the plurality of file fragments of this file and a second step 403 of distributing to each micro base station of the plurality of micro base stations for each file of the plurality of files the selected subset of the plurality of file fragments for caching the selected subset of the plurality of file fragments at the respective base station for being available for download by the user equipment.

By way of example, FIG. 5 shows a schematic diagram illustrating a base station 100 configured to manage the distribution of a plurality of files to a plurality of user equipment according to an embodiment implemented in the context of an exemplary heterogeneous network (HetNet) topology. By way of example, the plurality of micro base stations are deployed according to a regular grid with a distance d=60 meters between each micro base station. For the sake of clarity only four exemplary micro base stations are referenced in FIG. 5, namely the micro base stations 109a-d. By way of example, the service area 100a of the base station 100, which is assumed to be circular, has a coverage radius of D=500 meters. In order to reach any user equipment in the service area 100a of the base station 100, each micro base station has a service area of radius r such that d/√2≤r≤d, which means that the respective service areas of the micro base stations are overlapping as can be taken, for instance, from the highlighted square shown in FIG. 5. For this exemplary arrangement the coefficients A^{k}ᵢ can be theoretically approximated using simple geometrical calculations. By way of example, the plurality of user equipment are assumed to be uniformly distributed within the service area 100a of the base station 100 with a density ρ=0.05 (user equipment)/m². For the sake of clarity only three exemplary user equipment are referenced in FIG. 5, namely the user equipment 111a-c. The exemplary parameters chosen above correspond to an exemplary total of 316 micro base stations covering an exemplary total of 31415 user equipment.

In order to evaluate the performance gain from optimally distributing file fragments from the base station 100 to the plurality of micro base stations according to embodiments of the invention, in the below the achievable backhaul rate R₍ₒₚₜ₎ obtained by the optimal file fragments distribution scheme C₍ₒₚₜ₎ provided by embodiments of the invention is compared with three other distribution schemes, namely:
1) uniform distribution scheme C_{(unif)}: the file fragments are placed uniformly at each micro base station, i.e. each micro base station stores Mn/N fragments of each file. The achievable backhaul rate using this scheme is denoted as R_{(unif)};
2) “most popular” distribution scheme C₍ₚₒₚ₎: each micro base station stores entirely the M most popular files, i.e., all the fragments of the files F₁, . . . , F_{M} are stored in all the micro base stations. The achievable backhaul rate using this scheme is denoted as R₍ₚₒₚ₎;
3) proportional distribution scheme C₍ₚᵣₒₚ₎: for each file Fⱼ, the number of fragments mⱼ stored at the micro base stations is proportional to its popularity pⱼ while satisfying the storage constraints. The achievable backhaul rate using this scheme is denoted as R₍ₚᵣₒₚ₎.

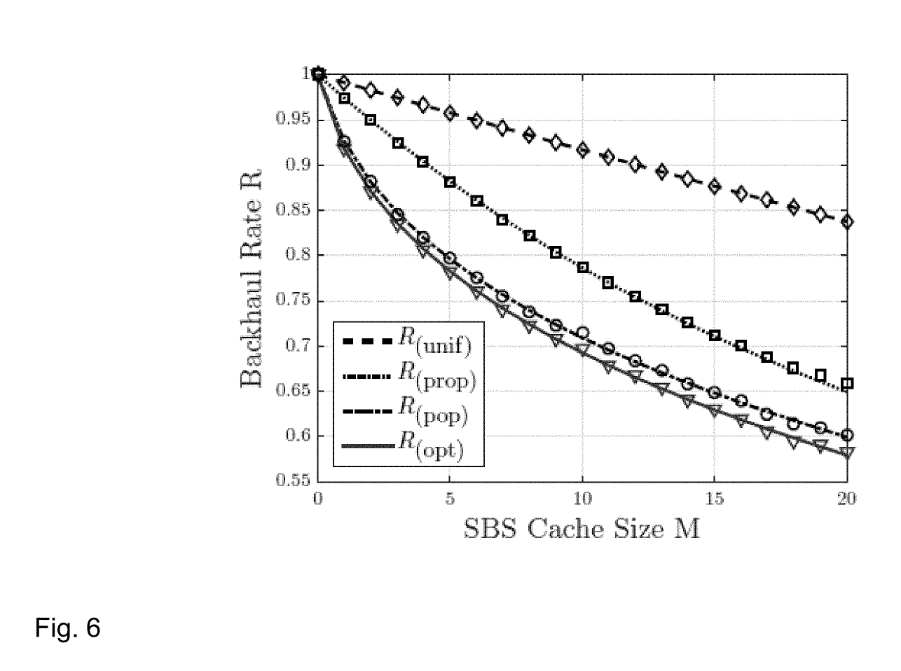

The validity of the theoretical results presented herein can be taken from FIG. 6, which shows the backhaul rates based on the theoretical results presented herein and the backhaul rates obtained from actually simulating the file distribution for the four distribution schemes described above as a function of the cache size M of each micro base station. By way of example, user equipment file requests are assumed to be randomly drawn according to a Zipf law of parameter α=0.7. In FIG. 6 the lines depict the theoretical backhaul rates, while the markers depict the simulated distribution scheme procedure. As there is an excellent matching between the average theoretical backhaul rates and the simulated backhaul rates, in the below only the theoretical backhaul rates will be discussed in more detail for the four different distribution schemes defined above. As already mentioned above, FIG. 6 shows the backhaul rates as a function of the cache size M of the micro base stations. As expected, the backhaul rates are decreasing when the storage capacity M of the micro base stations increases and the optimal distribution scheme provided by embodiments of the invention outperforms the three other distribution schemes. Furthermore, one observes that the difference between the backhaul rate R₍ₒₚₜ₎ provided by the optimal distribution scheme according to an embodiment of the invention and the backhaul rates provided by the other distribution schemes increases as the cache size M increases. Finally, one can notice that the “most popular” distribution scheme C₍ₚₒₚ₎ performs the closest to the optimal distribution scheme according to an embodiment of the invention. However, the rather small difference in terms of backhaul rates is due to a rather small overlap of service areas of neighboring micro base stations for the exemplary geometric configuration chosen for FIG. 6 and becomes larger for a different choice of parameters.

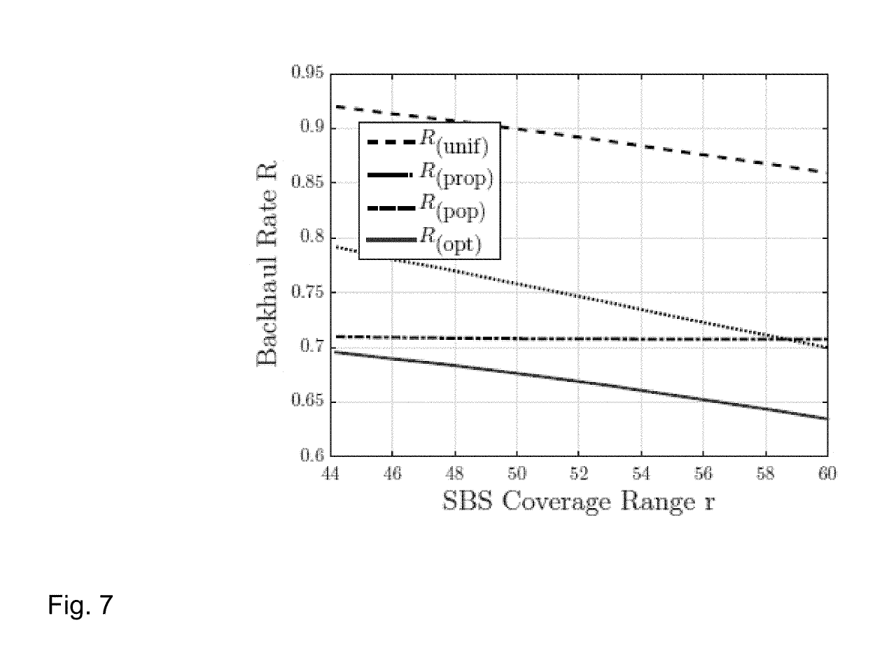

FIG. 7, which shows a schematic diagram illustrating the backhaul rate as a function of the micro base station coverage radius r for the four different file distribution schemes described above, confirms the previous results from FIG. 6 that the optimal distribution scheme provided by embodiments of the invention outperforms the three other distribution schemes. A striking behavior for the C₍ₚₒₚ₎ distribution scheme can be identified in FIG. 7, as its backhaul rate does not depend on the micro base station coverage radius, i.e. is constant. This behavior is due to the most popular files being stored at the micro base stations for this scheme: being served by more micro base stations does not increase the probability of having access to new files since the same files are stored in every micro base station. In contrast to the C₍ₚₒₚ₎ distribution scheme, the performance of the other distribution schemes increases as the micro base station coverage area increases, and noticeably the optimal scheme provided by embodiments of the invention significantly outperforms the other two schemes for larger radii, which can be illustrated by the following example. For a scenario, where there are 200 files each of size 100 Mbits, e.g. video files, the difference between the optimal backhaul rate R₍ₒₚₜ₎ provided by embodiments of the present disclosure and the second best backhaul rate R₍ₚᵣₒₚ₎ is 0.07 for r=60. This represents a difference of backhaul load of 7 Mbits/s if there is 1 file demand per second in the macro cell defined by the base station 100, which is a considerable gain for today's maximal backhaul capacities.

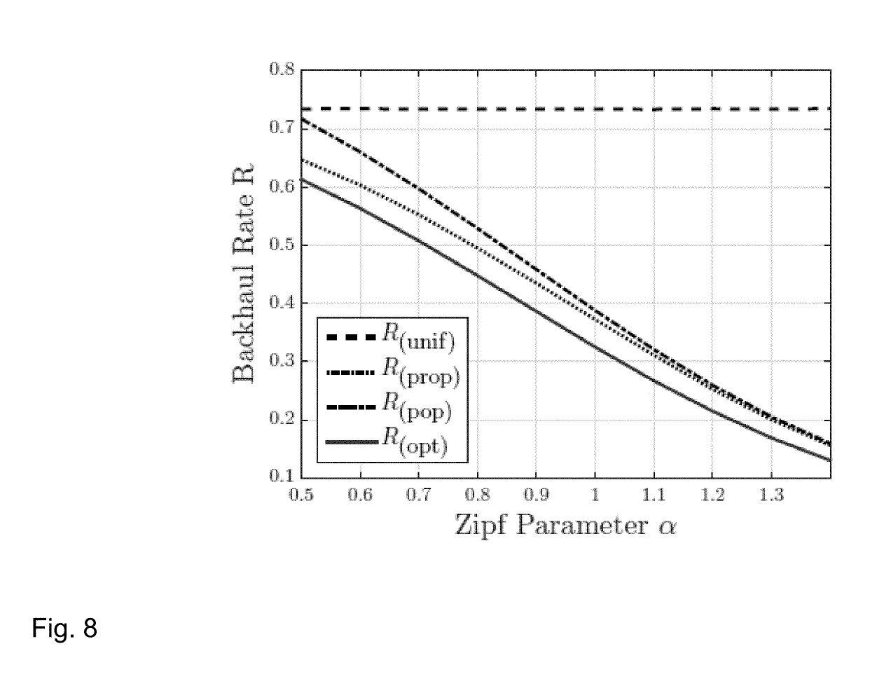

FIG. 8 shows a schematic diagram illustrating the backhaul rate as a function of the Zipf parameter for the four different file distribution schemes described above. As already described above, the smaller the value of the Zipf parameter α is, the more “uniform” the request probability distribution or file popularity is. This fact explains why for the smallest value of α=0.5 in FIG. 8, all schemes exhibit a comparable performance. However, since the uniform distribution scheme C_{(unif)} does not exploit the statistics of the request distribution, the backhaul rate performance of this scheme does not improve as α grows larger in contrast to the other schemes. Since a micro base station coverage radius of r=60 meters has been assumed for deriving the results shown in FIG. 8, one can observe, for the reasons already explained in the context of FIG. 7, that the proportional distribution scheme C₍ₚᵣₒₚ₎ outperforms the “most popular” distribution scheme C₍ₚₒₚ₎. For both these distribution schemes, i.e. C₍ₚᵣₒₚ₎ and C₍ₚₒₚ₎, the achievable backhaul rates are substantially larger than the backhaul rate of the optimal distribution scheme provided by embodiments of the invention.

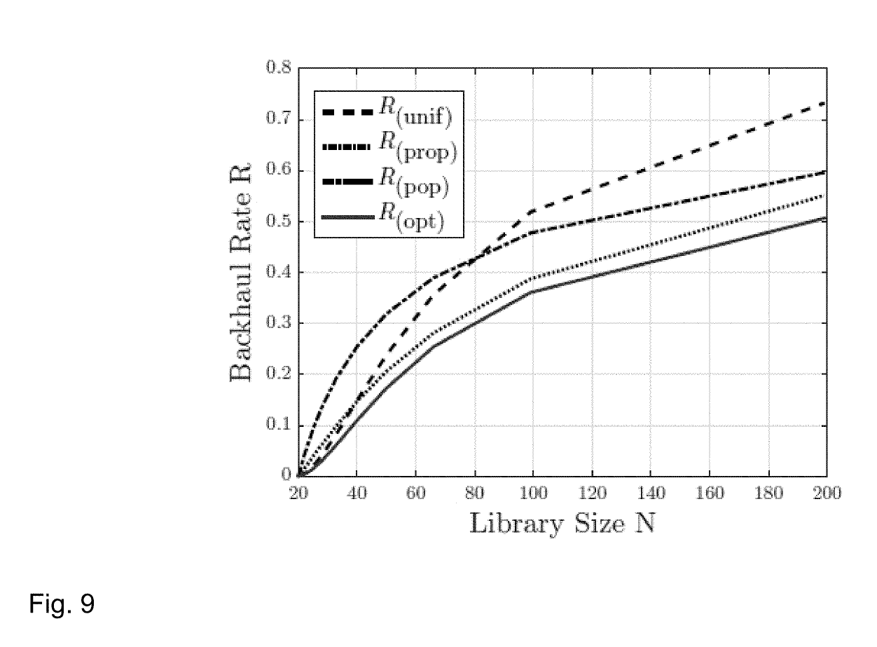

FIG. 9 shows a schematic diagram illustrating the backhaul rate as a function of the number of files N for the four different file distribution schemes described above, while keeping the cache size M of the micro base stations constant. For small library sizes, i.e. small numbers of files N, the “most popular” distribution scheme C₍ₚₒₚ₎ is outperformed by the other distribution schemes, as a spreading of the file fragments over the micro base station caches is more efficient than only storing a few number of complete files. On the other hand, as the library size N increases, the performance of the “most popular” distribution scheme C₍ₚₒₚ₎ becomes better in comparison to the other distribution schemes. The C₍ₚₒₚ₎ distribution scheme, however, is still outperformed by the C₍ₚᵣₒₚ₎ distribution scheme, since for this example a micro base station coverage radius of r=60 meters has been assumed, which is unfavorable for the C₍ₚₒₚ₎ distribution scheme. Also this figure clearly shows how the optimal file fragments distribution scheme C₍ₒₚₜ₎ provided by embodiments of the invention outperforms the three other distribution schemes, in particular for a large number of files N.

Embodiments of the disclosure provide for a significant reduction of the backhaul load, which is usually the bottleneck in current wireless communication networks. Embodiments of the present disclosure allow exploiting the characteristics of future wireless networks, such as HetNets, 5G, and the like, namely the spatial redundancy provided by overlapping service areas of micro base stations and cheap storage capabilities at the edge of the wireless communications network. Embodiments of the disclosure significantly outperform current file distribution or content caching schemes with respect to latency reduction and backhaul offloading. Embodiments of the disclosure inherently support user mobility (in fact mobility enhances performance). Embodiments of the disclosure can be efficiently implemented for various network topologies and can be further improved by optimizing the deployment of micro base stations.

While a particular feature or aspect of the disclosure may have been disclosed with respect to only one of several implementations or embodiments, such feature or aspect may be combined with one or more other features or aspects of the other implementations or embodiments as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the invention beyond those described herein. While the present disclosure has been described with reference to one or more particular embodiments, those skilled in the art recognize that many changes may be made thereto without departing from the scope of the present disclosure. It is therefore to be understood that within the scope of the appended claims and their equivalents, aspects of the invention may be practiced otherwise than as specifically described herein.

1. A base station configured to manage the distribution of a plurality of files to a user equipment located within a service area of the base station, wherein each file of the plurality of files is decomposed into a plurality of file fragments, the base station comprising:
a selector configured to select, for each micro base station of a plurality of micro base stations located within the service area of the base station, and for each file of the plurality of files, a subset of the plurality of file fragments of the file; and
a distributor configured to distribute to each micro base station of the plurality of micro base stations, for each file of the plurality of files, the selected subset of the plurality of file fragments to cache the selected subset of the plurality of file fragments at respective micro base station, such that the selected subset of file fragments is available for download by the user equipment.

2. The base station of claim 1, wherein the base station further comprises a memory configured to store the plurality of file fragments.

3. The base station of claim 1, wherein the base station further comprises a decomposer configured to decompose each file of the plurality of files into the plurality of file fragments.

4. The base station of claim 1, wherein to select the subset of the plurality of file fragments of the file, the selector is further configured to select, for each micro base station and for each file, the file fragments of the plurality of file fragments randomly.

5. The base station of claim 1, wherein to select the subset of the plurality of file fragments of the file, the selector is further configured to select, for each micro base station, the same number of file fragments of the plurality of file fragments.

6. The base station of claim 1, wherein to select the subset of the plurality of file fragments of the file, the selector is further configured to select, for each micro base station, the same number of file fragments of the plurality of file fragments, wherein the number of file fragments for a given file depends on a demand of the given file.

7. The base station of claim 6, wherein the selector and the distributor are configured to periodically adapt the selection and distribution of file fragments to the plurality of micro base stations on the basis of a changing demand of the plurality of files.

8. The base station of claim 1, wherein to select the subset of the plurality of file fragments of the file, the selector is further configured to minimize at least one of an average backhaul rate, a time delay, or energy consumption.

9. The base station of claim 1, wherein to select the subset of the plurality of file fragments of the file, the selector is further configured to determine normalized numbers of file fragments qⱼ, wherein 0≤qⱼ≤1 for all j from 1 to N for which the following equation is smaller than a predefined minimum threshold:
$${P}_{app} {=}^{Δ} {min}_{{q}_{1} , … , {q}_{N}} {\sum }_{i = 1}^{S} {\sum }_{j = 1}^{N} {a}_{i} {{p}_{j} ( 1 - {q}_{j} )}^{i} ,$$
wherein N denotes the number of files, S denotes the total number of micro base stations within the service area of the base station, aᵢ denotes proportion of user equipment covered by i micro base stations, pⱼ denotes a popularity measure of the j-th file and wherein Σⱼ₌₁^{N}qⱼ=M, wherein M denotes a measure for the cache size of the micro base stations for storing file fragments.

10. The base station of claim 1, wherein the distributor is further configured to distribute to each micro base station the selected subset of the plurality of file fragments at times when a network traffic is below a threshold.

11. The base station of claim 1, wherein the file fragments include file fragments of the same size.

12. The base station of claim 1, wherein each micro base station is configured to cache, for each file of the plurality of files, a respective subset of file fragments, such that the respective subset of file fragments is available for download by a user equipment.

13. A method of managing a distribution of a plurality of files to a user equipment located within a service area of a base station, wherein each file of the plurality of files is decomposed into a plurality of file fragments, the method comprising:
selecting by the base station, for each micro base station of a plurality of micro base stations located within the service area of the base station, and for each file of the plurality of files, a subset of the plurality of file fragments of the file; and
distributing by the base station to each micro base station of the plurality of micro base stations, for each file of the plurality of files, the selected subset of the plurality of file fragments to cache the selected subset of the plurality of file fragments at respective micro base station, such that the selected subset of file fragments is available for download by the user equipment.

14. The method of claim 13, wherein selecting the subset of file fragments comprises determining normalized numbers of file fragments qⱼ, wherein 0≤qⱼ≤1 for all j from 1 to N for which the following equation is smaller than a predefined minimum threshold:
$${P}_{app} {=}^{Δ} {min}_{{q}_{1} , … , {q}_{N}} {\sum }_{i = 1}^{S} {\sum }_{j = 1}^{N} {a}_{i} {{p}_{j} ( 1 - {q}_{j} )}^{i} ,$$
wherein N denotes the number of files, S denotes the total number of micro base stations within the service area of the base station, aᵢ denotes proportion of user equipment covered by i micro base stations, pⱼ denotes a popularity measure of the j-th file and wherein Σⱼ₌₁^{N}qⱼ=M, wherein M denotes a measure for cache size of the micro base stations for storing file fragments.

15. A computer program comprising instructions that perform the method of claim 13, when executed on a computer.
